(19) United States
(12) Patent Application Publication
(10) Pub. No.: US 2009/0255702 A1
(43) Pub. Date: Oct. 15, 2009

(54) Organizing and wire management system

(76) Inventor: Chad Mitchell, San Antonio, TX (US)

Correspondence Address: Chad Mitchell, 14080 Nacogdoches, #160, San Antonio, TX, 78247-1944, US

(21) Appl. No.: 12/148,093

(22) Filed: Apr. 15, 2008

(51) Int. Cl. H01J 5/00

(52) U.S. Cl. 174/50

(57) ABSTRACT

An organizer and/or wire management apparatus generally comprises an elongate support member having a resilient coaxial strip. The support can additionally have holder attachments from one to a plurality according to user needs or desires. The holder attachments can be permanently joined or mutually engaged and disengaged with the use of a holder attachment mechanism and located according to user preference. The holder attachment mechanism can be joined to any kind of holder that can be supported by such mechanism and apparatus. The elongate support member can be supported in a variety of different orientations including but not limited to horizontally and vertically. Or, the elongate support can be in a freestanding arrangement to become an independent freestanding organizer or assist organizing in proximity of a structure such as a desk or entertainment center. Or, the apparatus can be the basis or part of a structure that is a desk, desk-like, entertainment center, or entertainment center like complete structure.

### FEDERALLY SPONSORED RESEARCH

Not Applicable

### SEQUENCE LISTING OR PROGRAM

Not Applicable

### INCORPORATION BY REFERENCE

Applicant hereby incorporate herein by reference, any and all U.S. patents, U.S. patent applications, and other documents and printed matter cited or referred to in this application.

### COPYRIGHT NOTICE

©2008 Chad Mitchell. Portions of the disclosure of this patent document contains material (including the drawings) that is subject to copyright protection. The copyright owner has no objection to the facsimile reproduction by anyone of the patent disclosure, as it appears in the Patent and Trademark Office patent files or records, but otherwise reserves all copyright rights whatsoever.

### BACKGROUND OF THE INVENTION

1. Field of the Invention

This invention relates generally to office related organizers, entertainment center cabinets, wire management devices, and outer space from Earth organizers. More specifically, the present invention relates to an elongate support with a coaxial resilient strip to wedge wires and/or various items into or through a channel at user defined location(s) thereof.

2. Discussion of the Field and Related Art

### Terms Defined for Clarity:

At time of submittal of the present invention patent application, another relative art patent application is pending (U.S. Ser. No. 11/542,440 entitled “Organizer attachable to a chair and task utility system and process of providing same”) by same named inventor herein. Such patent application is of relative art. Accordingly, such patent application is referred to. What is currently (at time of submittal of the present invention patent application) referenced such U.S. patent application Ser. No. 11/542,440 by the USPTO is hereinafter referred to as “merging technology possible invention”.

Terminology of “NASA”: The National Aeronautics and Space Administration of the USA is hereinafter referred to as NASA.

Terminology of “desk items”: Various items and implements normally associated with working at a desk and organized on traditional desktop organizers include pens, pencils, transparent tape, paper clips, notepads, adhesive-backed notes, rulers, push pins, rubber bands, scissors, staplers, and the like. Though certain concepts of the present invention challenge the notion that such items normally associated with working at a desk should necessarily or in all cases be organized on or with such, for facilitated understanding of the invention, such items and implements are hereinafter referred to as “desk items” even when a desk is not being used in an example of usage, except in instances which may require that the specific item be mentioned.

Terminology of “portable electronic devices”: Various items normally associated as personal mobile electronic devices such as digital cameras, MP3 players, PDA's (portable digital assistants), electronic organizers, cell or mobile phones, I-PODS, electronic dictionaries, calculators, and the like are hereinafter referred to as “portable electronic devices” except in instances which may require that the specific item be mentioned.

Terminology of “electronics wires”: Wires that extend from portable electronic devices, computer monitors, computer peripherals, audio and visual peripherals or the like to be in communication with computers or other electronics are hereinafter referred to as “electronics wires.” Though it may not be necessary to differentiate electronics wires apart from electrical wires (wires that are used for electricity power) when describing the present invention, the separate terminology is hereby included herein for possible clarity reasons.

As technology increases, braches of progress take place. For example, in one branch, wire management devices are evolving to handle portable electronic devices and auxiliary devices. There is various wire management devices to direct wires to charge and recharge batteries to such, and to allow electronic devices to be in communication with other electronic devices, etc..

Yet, in another branch of technology, the theory of progress is to make what is known as wireless devices for communication to other electronic devices. And to make longer lasting batteries, less power requiring devices and such for less dependence on having external wires, whether for electricity or for electronic communication of devices.

Currently, both wired and wireless devices have advantages and disadvantages comparatively. Wireless devices offer a form of convenience, while externally wired devices tend to offer better data security and reliability. Though the debate between wired and wireless devices is not the focus of the present invention, it is mentioned herein because the present invention serves either external wired or wireless devices effectively. Essentially, many persons may use either or both externally wired and wireless devices.

The present invention addresses a variety of issues and topics associated with organization. One issue concerns wire management. On one front, the present invention approaches such issue with the premise that wires are simply yet another item that may need to be effectively managed for organization. Yet, on another front of the present invention, wires may be the only item/s that need to be effectively managed for organization.

Another issue concerns a gravitational negligible environment, or an environment in which normal earth gravity depended upon currently by most persons in conventional organization, is not the condition in which an organizer will need to be used. Astronautically and otherwise, there is a need for organization in which items will not float or detach away from an organized location. Yet, such items need to be relatively easy to retrieve and place back again at an organized location. For example, in an environment outer space from earth by NASA, or by the privatized ventures for space exploration and vacation, persons will use many of the same items in such environment as they do in a normal earth gravity environment whether for doing office related work, or leisure. For example, such items may be cameras, phones, scissors, or any items that persons are accustomed to having in an organized location according to their choosing. A problem may arise in such environment, especially when a person is accustomed to placing such item/s down for example, on a normal earth gravity level plane surface, when done for the moment using such item/s. The problem being that those item/s may then float or detach away to an unorganized, and possibly even unsafe area for such item/s.

In another issue, progressive organization is needed in an office, home office, or the like environment. This issue is well defined and quite effectively addressed in a merging technology possible invention by same current inventor of the present invention. However, the present invention offers advantages and disadvantages comparatively to such other merging technology possible invention in such issue. For example, the present invention has in one of its various possible embodiments, an embodiment that can completely take the place of the elongate support structure described in the merging technology possible invention with eased wire management, but is more financially expensive to manufacture. Also, the described vertical support to hold the elongate support structure in the merging technology possible invention is designed for the described possible multi-use of chair, desktop, and freestanding organization and utility usage. And wires can drop down through the vertical support more freely and loosely than with the technology of the present invention, which may or may not be desired by the user. Whereas, the present invention has found new and additional uses not previously described, and thus offers different preferred embodiments to accommodate such uses. However, it will become obvious to those skilled in the art that various aspects of the technology of the merging technology possible invention, and the present invention can be combined to accommodate user needs or desires.

In still yet another issue, home entertainment and multi-media systems need organization and decor capabilities, either built-on, or surrounding such, especially in which wires can be managed from nearly any point. In furniture such as modern home entertainment center cabinets, wire management capabilities are often built-in or integrated. However, such capabilities are most often at a centralized location such a common post, which is most often located in the rear of the cabinet. The problem with such obvious kind of wire management is that a wire or wires from a device may be leading from the left, right, center, side, or even from the front of the object device. For example, in many home stereo systems, and DVD players, there is outlets for wire connections on the side or front of such for dubbing or allowing electronic communication from a video game system so that the sound can be heard through the speakers of the home stereo system rather than the built in inferior speakers. There is a need for safety and decor purposes to have user controlled location wire management.

Various other wire management issues, include for example, in conditions of thrust and gravitational negligible environments, wire management may need to be relatively snug to avoid entanglement to other wires and objects. And whether in a gravitational negligible environment or not, wires should be able to diverge to or from a wire management device at a location that an item that needs wire management is placed at.

The following prior art may be related to an aspect of the present invention:

Londrico, U.S. Pat. No. 7,028,854, describes an organizer including resilient retaining members; Rempel U.S. Pat. No. 3,812,976, describes a rack for holding tools or similar objects; Niederberger U.S. Pat. No. 5,419,443 describes a holder for tools and other objects; and Drower, et al. U.S. Pat. No. 5,779,066 Storage rack with retainer loops maintaining uniform pressure against the articles being held.

Among other limitations in such patents, the patents do not teach a product with a general structure that can facilitate freestanding, structure assistance organizing, and various mounting capabilities at various angles to various structures. Also, the resilient retaining means are either not taught to be used with possible additional purposes such as for a gravitational negligible, thrusting, or upside-down environment; And/or, items may not be as easily able to be retrieved, or able to be placed back in the same or different locations with as relative ease as the present invention. Furthermore, all of which (if any wire management is taught) do not facilitate wire management of direct entry into a structure, and through from such point at any and different locations in which a wired device may be closest to.

The following prior art may also be related to an aspect of the present invention:

Luciere U.S. Pat. No. 7,028,854 describes a computer cable organizer which is limited to organizing cables or wires, and in a very limited way. For example, to those skilled in the art, the described Luciere organizer would appear to function best mounted substantially horizontally to the rear of a desk, wherein wires leading to or from a device but must first travel a considerable distance until entry into the Luciere cable organizer is obtained, leaving wires with a considerable length of such wires thereof exposed.

Gutgsell, et al. U.S. Pat. No. 6,523,795 describes a table leg wire management apparatus, and Frattini U.S. Pat. No. 6,389,988 describes an article of furniture including a leg having wire management capabilities. Such patents teach the abilities of wires to channel through a supporting leg. However, such patents do not teach the ability of wires to enter a supporting structure at virtually any location along the length of a supporting structure.

The present invention can address the issues and problems noted above and others which will become obvious after reading the following further descriptions and inspecting the drawings.

### Advantages

The present invention provides an apparatus and methods of use of such apparatus not taught by the prior art. Accordingly, the present invention may have one or more of the following advantages:
(a) It can provide possible expansion and remodeling capabilities for organization structures to accommodate various user needs or desires.
(b) It can provide the possibility of eased organization in an environment (such as in outer space away from earth), that is not dependent on conventional normal earth ground level gravitational force.
(c) It provides the possibility of an organizing apparatus that is effective in providing organization in both a conventional earth ground level gravity environment, and in an environment that is not dependent upon normal ground level earth gravity force. And thus furthermore, can help persons make a transition of accustomed organization in such different environments.
(d) It can provide eased and direct wire management capabilities that allow a wire or wires to diverge to or from a location that has a device organized at such I location which needs wire management of any wire/s in connection with such device.
(e) It provides an organizing apparatus that can be positioned in a variety of positions including but not limited to horizontally, vertically, and various diagonal positions.
(f) It can provide an organizing apparatus that can be positioned having an item receptacle portion thereof facing a variety of positions.
(g) It can provide an organizing apparatus that accommodates holding items in a variety of methods to accommodate various user needs or desires.
(h) It can provide an organizing or wire management apparatus that can be used as an independent organizing device, or made to provide structural capabilities to build a desk, desk-like, entertainment center cabinet system, or entertainment center-like cabinet system.

Aspects and other advantages of the present invention will become apparent from the following descriptions, taken in connection with the accompanying drawings, wherein, by way of illustration and example, an embodiment of the present invention is disclosed.

### BRIEF SUMMARY OF THE INVENTION

In accordance with a preferred embodiment of the invention, there is disclosed an organizer and structure apparatus that comprises an elongate support member and a resilient strip. The resilient strip is engaged or rigidly joined coaxially to at least a portion of the elongate support member. Thereby, items can be wedged between the elongate support member and the resilient strip at any location thereof chosen by the user. Also thereby, permitting the use if needed or desired, for electrical wires and/or electronics wires to wedge between the elongate support member and the resilient strip at any location thereof and extend through such embodiment and back out any location thereof.

In a further embodiment, at least one attachment mechanism can attach the embodiment to a planar surface of for example, a desk, desk-like, entertainment center, or entertainment center-like structure. In a preferred embodiment, the attachment mechanism/s permit the embodiment to be rotated inside such attachment mechanism/s. Thereby, permitting a receptacle portion of such embodiment to be angled toward a direction chosen by the user.

The embodiment can further have one or more holder attachment mechanism that attach to any kind of holder that will permit being supported by such holder attachment mechanism/s. A preferred embodiment permits such holder attachment mechanism/s to be able to be rotated in the area of placement. The holder attachment mechanism can be removably engaged or joined in a more permanent manner and positioned along the length of the elongate support member according to user preference.

In a further embodiment, a freestanding arrangement holds such embodiment in a substantially vertical position. Such arrangement can thereby be used as a freestanding organizer, and/or used to assist organizing and/or wire management capabilities of a desk, desk-like, entertainment center, or entertainment center-like structure.

In a further embodiment, the elongate support member can be used as a structure enabling element to build a desk, desk-like, entertainment center, or entertainment center like structure.

### BRIEF DESCRIPTION OF THE DRAWINGS

A complete understanding of the invention may be achieved in part by referring to the accompanying drawings, which constitute a part of the means for teaching those skilled in the art how to make and use the invention. It is to be understood that in some instances, to facilitate an understanding of the invention, the drawings may not necessarily be to scale and may be shown with various aspects exaggerated.

FIG. 1 is an isolated perspective view of one of the preferred embodiments in a possible usage method;

FIG. 2 is an exploded isolated perspective view of thereof not in use;

FIG. 3 is a cross sectional view taken along line 3-3 of FIG. 2 defining the a possible preferred width of a channel thereof depending on items to be inserted through such;

FIG. 4 is a perspective view showing how the invention can be freestanding, and also introducing holder attachment mechanisms in use with holders; Also to be noted is that the resilient strip is not shown for clarity of showing how the attachment mechanisms wrap around the embodiment;

FIG. 5 is a perspective illustration showing how the embodiment can be positioned on a desk or the like structure horizontal plane, and showing an optional wire passage via hole; Again, the resilient strip is not shown for clarity of showing an aspect;

FIG. 6 is an exploded perspective view showing how the original embodiment can join or engage to a stand base;

FIG. 7 is a perspective view showing how the elongate support member can be used as a structure enabling element to build a desk, desk-like, entertainment center, or entertainment center like structure; Also, depicting rotation ability of the original embodiment;

FIG. 8 is a perspective illustration showing one way of how such structure thereof could be built;

FIG. 9 is a perspective view showing how the invention can assist wire management of an entertainment center or the like structure;

FIG. 10 is a perspective illustration showing how the original embodiment can be attached to the vertical wall of a structure;

FIG. 11 is a top plan view of a base stand used for freestanding and/or structure building;

FIGS. 12-A and 12-B illustrate an attachment mechanism to attach the original embodiment to a planer area of a structure;

FIGS. 13-A and 13-B illustrate a holder attachment mechanism;

FIG. 14 is a perspective view of an alternative preferred embodiment of the invention;

FIG. 15 is an exploded perspective view thereof;

FIG. 16 is an isolated illustration of parts further shown in FIG. 17;

FIG. 17 is a perspective view of another alternative embodiment.

The terminology and phraseology which will be used in the following description is for purpose of description and illustration, and is used to refer to all technical equivalents which operate in a similar manner to accomplish a similar purpose. For example, the words “downwardly”, “upwardly”, “leftwardly” and “rightwardly” will refer to directions in the drawings to which reference is made. Thus, examples are clearly provided but are not limiting.

### DETAILED DESCRIPTION

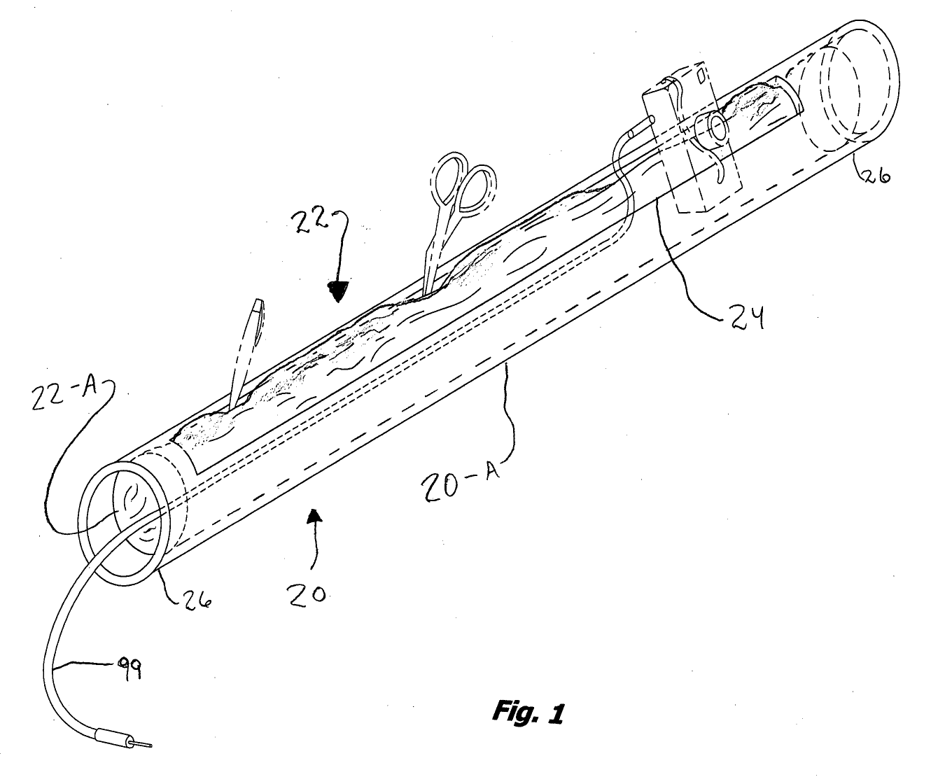

In accordance with the present invention, FIG. 1 illustrates a preferred embodiment in a possible use. The illustration shows a few possible items organized in locations hypothetically chosen by a user. Such items are illustrated to be inserted through an entry means, in such instance a channel 24, and wedged between a resilient strip 22 and the body of an elongate support member 20.

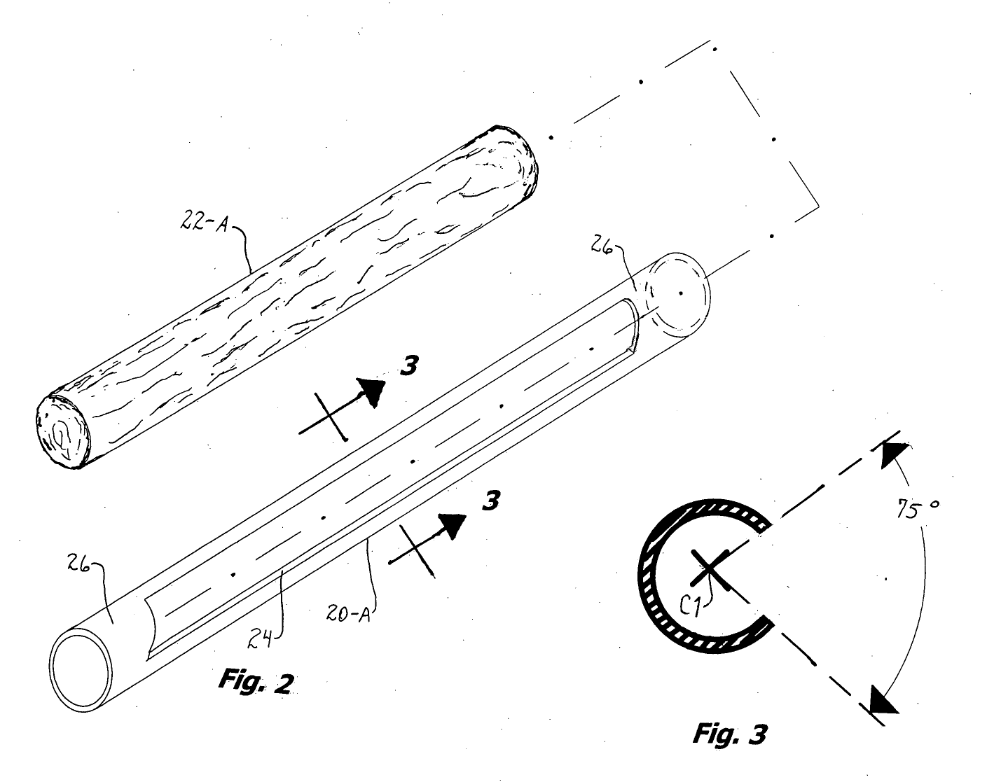

In FIG. 1 and FIG. 2 for example, the elongate support member 20 is demonstrated to be an encasing cylindrical tube-like structure 20-A made of a rigid, structural, light material such as aluminum or plastic. A cylindrical tube can become such shown tube-like structure 20-A by cutting out a portion from a cylindrical tube to form a cut-out or channel 24. The particular channel 24 illustrated in Figures such as FIGS. 1 and 2, is shown to be rectangular shaped. In the illustrated embodiment of the tube-like structure 20-A, the channel 24 extends from about 85 percent to about 95 percent of the longitudinal length of the tube-like structure 20-A. However, the channel 24 can extend the entire length of the tube-like structure 20-A. Thus, starting with a structure of a cylindrical tube for example, and cutting out such kind of channel 24, what started out to be a tube, may not be considered a tube after such kind of cuts are made. It could possibly be considered a semi-cylinder, but if end portions 26 are left intact, some persons may consider such to be a tube with an extended cut-out portion. Thus, when describing the particular elongate support member 20 such as illustrated in FIG. 1, and FIG. 2, the term tube-like structure 20-A is used.

If a cylindrical tube was cut in half longitudinally, then by using one of the halves of the two semi-cylinders or divided structures, an embodiment of the present invention could still be made by gluing a portion of a resilient strip 22 (described later) to the concaved side of what would then be the elongate support member 20. However, in such kind of embodiment, it may be difficult to attach holder attachment mechanisms 50 (described later) rotatably at more of the 360 degree possible angles of attachment. Therefore, the angles of attachment for holder attachment mechanisms may then be limited. Because as opposed to the tube-like structure 20-A shown, which has more of a complete circular outer wall, half of a cylindrical tube would potentially interfere with rotation ability of holder attachment mechanisms (described later). Furthermore, such kind of embodiment may then limit the resilient strip 22 to being joined to the elongate support member 20 in a more permanent fashion, rather than allowing the manufacturing capability of engaging the resilient strip 22 to the elongate support member 20. Thus, the portion of cut from width of the tube-like structure 20-A is preferably such that would take into consideration rotatability of holder attachment mechanisms 50 in case a user may want to add such to the embodiment at various angles of attachment. And/or take into consideration engagement of a resilient strip 22 in an encasing-like manner. And/or take into consideration the width of items to be organized through such channel 24. In the particular embodiment of the tube-like structure illustrated, the portion of the channel 24 extends from about 85 percent to about 95 percent of the longitudinal length of the tube-like structure (as previously described). While in the illustrated embodiment, the perpendicular to such (width) dimension of the channel 24 is such as to define a generally quarter-circle configuration of what would be the full circle of cross section of a cylindrical tube. And in the illustrated embodiment, the width of the channel 24 is shown how it can be planned to extend through an angle of from about 30.degree to about 120.degree when shown in a cross sectional view from an imaginary center point C1 that would be in the center of circumference of cross section of a cylindrical tube if the tube-like structure 20-A was a complete cylindrical tube. The width of the channel 24 is to be planned according to the overall width of the tube-like structure 20-A, and most likely items to be inserted through such channel 24.

As previously described, in the illustrated embodiment of the tube-like structure 20-A, the particular channel 24 shown, extends from about 85 percent to about 95 percent of the longitudinal length of the tube-like structure 20-A. However, such channel 24 can extend through a portion that is to be determined by the overall longitudinal length of the tube-like structure 20-A, how many and what kind of items are to be inserted through such channel 24, the arrangement in which the tube-like structure 20-A is to be set up, and decorative and or ornamental design features of such tube-like structure 20-A. In the illustrated embodiment, the channel 24 is shown to be centered between two end portions 26. However, where the channel 24 is located is also to be determined by the overall longitudinal length of the tube-like structure 20-A, how many and what kind of items are to be inserted through such channel, the arrangement in which the tube-like structure 20-A is to be set up, and decorative and or ornamental design features of such tube-like structure. Also to be noted is the the end portions 26 preferably have open ends.

Referring particularly to FIG. 2, in an exploded view, a better view is illustrated of a resilient strip 22, which in the particular embodiment illustrated, is demonstrated to be a cushion 22-A. The cushion 22-A is preferably made of foam and of a resiliency similar to that commonly made for furniture such as sofas and bedding, such as that made generally from regular polyurethane, or similar kind of bounce-back or sponge-like material. However, it can also be made from what is commonly known as memory foam or visco-elastic polyurethane foam. The resiliency of the cushion 22-A should be puissant or firm enough to hold or engage items relatively securely in place when wedged between the concaved side of the tube-like structure 20-A and the cushion 22-A. However, the resiliency of the cushion 22-A should not be too puissant or firm that it would substantially interfere with ease of inserting items between the concaved side of the tube-like structure 20-A and the cushion 22-A. The resilient strip 22 could also be made from materials such as cotton in the same manner that pillows are made if encased inside a fabric such as vinyl, leather, or cloth.

In the illustrated embodiment, referring to FIG. 1 and FIG. 2, the cushion 22-A when inserted inside of the tube-like structure 20-A, preferably extends from each end of the longitudinal length of the channel 24 of the tube-like structure 20-A. Thus leaving the end portions 26 thereof hollow for wire passage ease in case a user uses the invention for possible wire management through the end portions 26. The cushion 22-A preferably engages inside of the concaved side of the tube-like structure 20-A. Thus, the cushion 22-A is of congruent cross sectional shape on its out width wall as the inner width wall of the end portions of the tube-like structure 20-A having a similar diameter. However, because the cushion 22-A is resilient, it can have a slightly larger diameter outer width wall than the end portions 26 inner width wall of the tube-like structure 20-A. Thus, allowing the cushion 22-A to bulge into or slightly through the channel 24 of the tube-like structure 20-A. The cushion 22-A in the illustrated embodiment extends coaxially through the tube-like structure 20-A in at least a portion thereof. However, the resilient strip 22 or cushion 22-A can extend over rather than through the elongate support member 20. For example, if a resilient strip 22 such as a cushion were cylindrical or tube-like, a stick, rod, or shaft could be inserted through such designed resilient strip 22, and thus, the elongate support member 20 would extend through the resilient strip 22 coaxially in at least a portion thereof. However, if the resilient strip 22 is made to be the covering embodiment over the elongate support member, holder attachment mechanisms 50 (described later), if such are chosen to be used by a user, may not function as effectively as having the elongate support member 20 having the more exposed exterior wall. Also to be noted is that the resilient strip 22 can be cut into two or more sections, and the plurality of resilient strip 22 sections can extend coaxially at a variety of portions of the elongate support member 22.

Though not shown, the cushion 22-A is preferably surfaced with a decorative fabric such as vinyl, leather, or other materials, as are commonly used for surfacing furniture such as a sofa or couch. Also, though not shown, the tube-like structure 20-A can also be covered in decorative fabric such as leather, vinyl, or other materials, as are commonly used for surfacing furniture, which may be desired to match such decorative fabric that may surface the cushion 22-A. And the channel 24 provides a method to wrap such decorative fabric around such tube-like structure 20-A without visible seams. The decorative fabric would wrap around the convexed side of the tube-like structure 20-A, and into a portion on both sides of the concaved side of the tube-like structure 20-A, wherein the decorative fabric can be glued to portions of the inside wall of the tube-like structure 20-A.

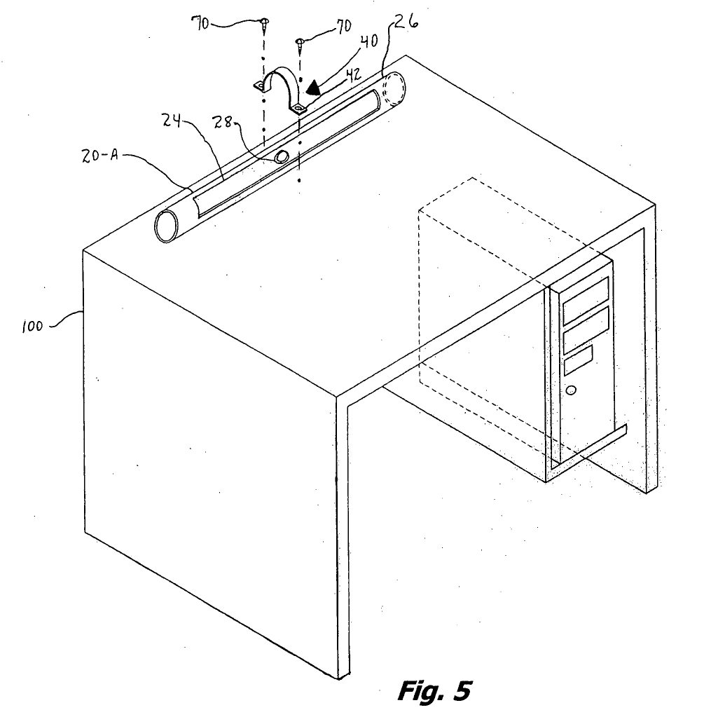

Referring to FIG. 5, the tube-like structure 20-A is shown without the cushion 22-A to show that the elongate support member may have at least one additional or optional wire flow or via passage or hole 28. Such hole 28 would be large enough so that at least one electrical or electronics cable or wire 99 and associated plug type can pass through such hole 28. However, such hole 28 would preferably be of large enough diameter to provide a communal wire passage means for a plurality of cables or wires 99. If only one hole 28 was made, such hole 28 would preferably be located centrally at opposing side of the channel 24 of the tube-like structure 20-A. Such hole 28 could be of many possible shapes such as circular as shown. Such hole 28 would be particularly helpful if the elongate support member 20 or tube-like structure 20-A were arranged in a horizontal attitude such as on a desk 100 or the like structure.

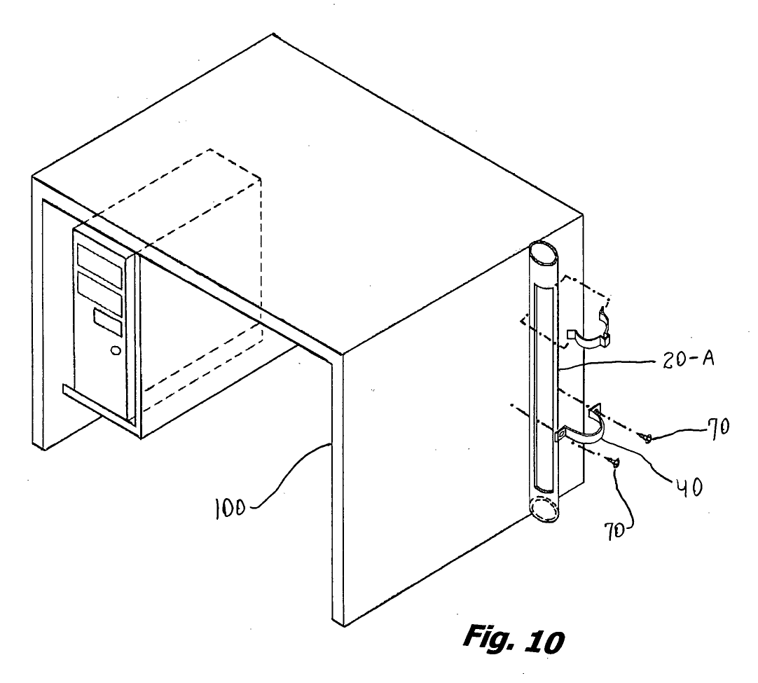

The invention also includes an attachment mechanism. In the illustrated embodiment as shown in FIG. 5, to hold the elongate support member 20 in place, an attachment mechanism 40 is used. The attachment mechanism 40 is preferably of substantially congruent shape as the outer wall of the tube like structure 20-A. For example, the tube like structure 20-A is substantially cylindrical shaped, thus the attachment mechanism 40 illustrated is formed of a semi-cylinder and of a diameter to fit snug around the tube like structure 20-A. If desired, fasteners such as screws 70 can be joined through the holes 42 as shown in FIGS. 5, and 10 of such attachment mechanism 40 and into a further supporting structure such as the desk 100 shown in FIG. 5 and FIG. 10.

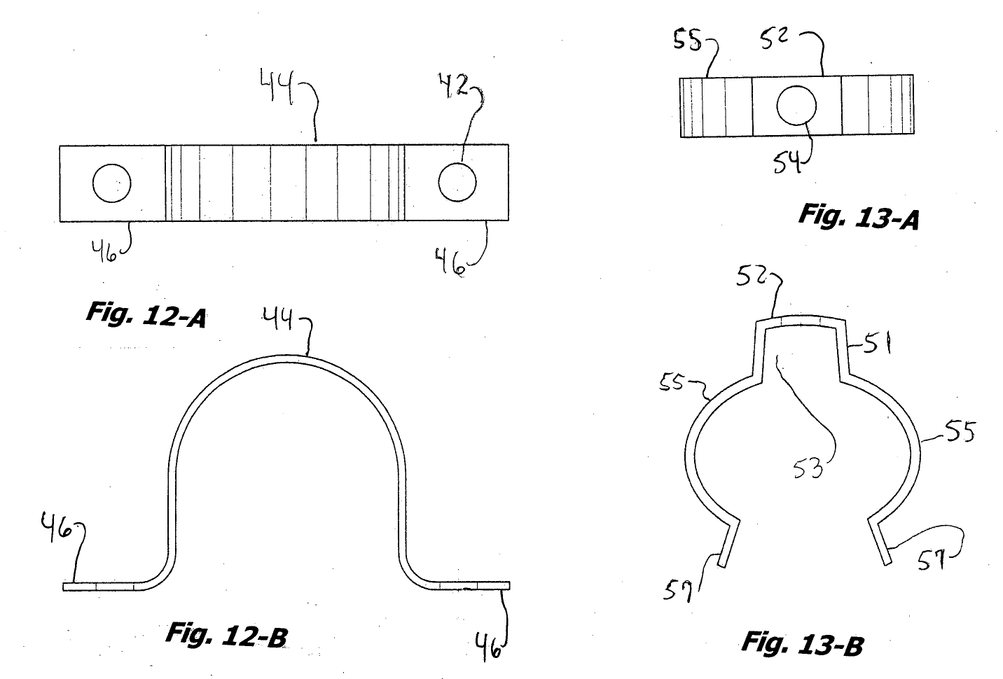

Referring particularly to FIGS. 12-A and 12-B, the illustration shows a body 44 of the attachment mechanism 40 and planar butting flanges 46. The body 44 is the part which fits snug to the tube like structure 20-A. The butting flanges 46 form a butt joint to preferably a planar surface of a further supporting structure. The holes 42 are preferably located centrally on each of the butting flanges 46. The butting flanges 46 are at each end of the body 44 of the attachment mechanism 40 extending radially from such. The attachment mechanism 40 is preferably made of a flat rigid spring tempered material such as metal of the kind to make a spring-clamp. As shown in FIGS. 5 and 10, The attachment mechanism 40 can secure the tube like structure 20-A vertically, horizontally, and various diagonal positions. But fasteners are not needed if the tube like structure 12 is placed on a horizontal plane structure such as a desk 100 because the butting flanges can hold such in place by a means of a butting engagement, if the body 44 is relatively snug to the tube-like structure. One or more attachment mechanisms 40 can be used depending on the length of the elongate support member 20 and desired stability.

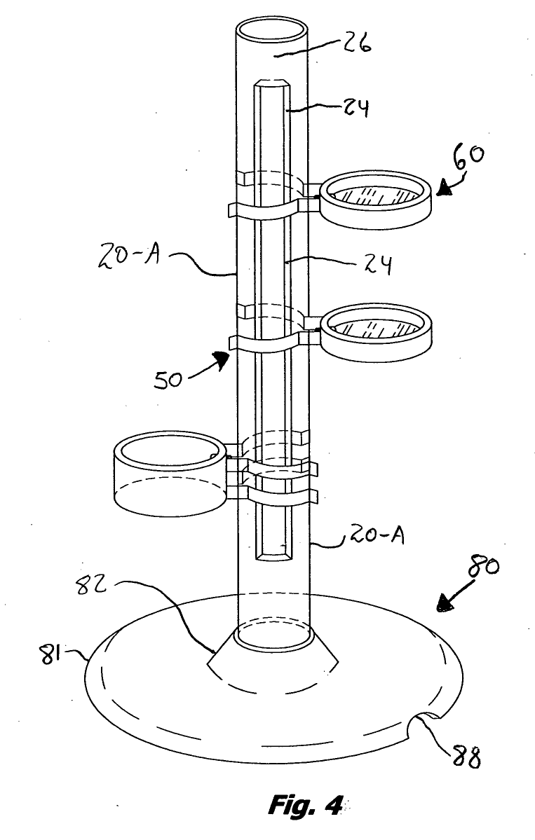

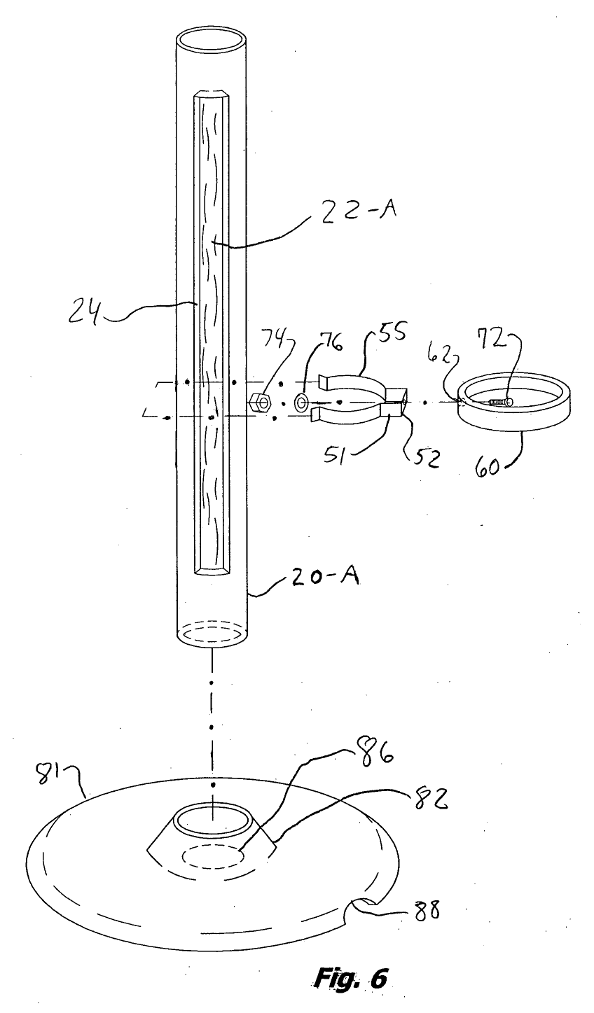

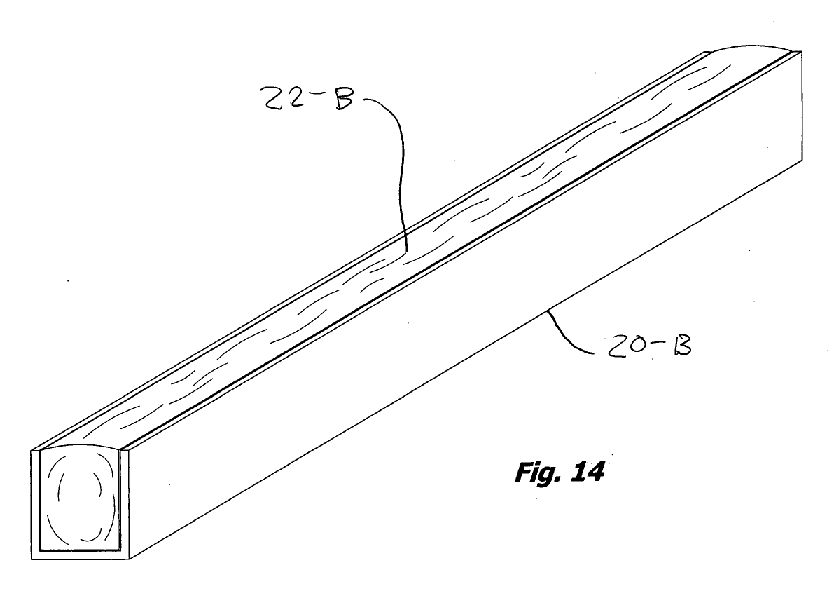

Referring to FIG. 4 and FIGS. 13-A and 13-B, the invention also includes a holder attachment mechanism 50. The holder attachment mechanism 50 can be effectively used on a supporting structure that is in any substantially common alignment such as horizontal, vertical, or even diagonal. The attachment mechanism 50 can attach to many kinds of holders or receptacles of items as long as either a bottom, side, or top wall of such holder is structural enough to attach to a butt flange 52. In the illustrated embodiment, the holder attachment mechanism 50 is conveyed to be made preferably of a substantially rigid yet relatively resilient material such as thin flat spring tempered metal and like a spring clamp. Preferably integrating from the central area of the holder attachment mechanism 50 is a holder attachment butt flange 52 which flattens on the side which will butt up against and join to any appropriately possible and various holder 60 such as shown in FIG. 6. At the central area of the flange 52 is an aperture 54 for a screw 70, or bolt or other type of fastener which will join through such aperture 22 and fasten to preferably a flat portion part of any appropriate holder 60. If a holder 60 is to be positioned from a substantially vertical support, it can attach from either the side or back of such appropriate holder 60. If the holder is to be positioned from a substantially horizontal support, it can be attached from either the underside or the upper side of such appropriate holder 60. The flange 52 can attach to any appropriate holder for example, by screwing a pointed screw through the aperture 54 of the flange 52 and into such appropriate holder 60, or preferably by joining a nut 74 to a bolt 72 and tightening the nut 74 to a washer 76 which will be tightened to the inside of the flange 52 as shown in FIG. 6. Or, in some instances by simply gluing the flange 20 to an appropriate holder. For example, if the underside of a holder was butting up against the flange 52 and was substantially horizontal, glue may be sufficient to hold such in place. Preferably, the flange 52 is joined and bolted to the appropriate holder by firstly pre-drilling an appropriate sized hole 62 into the area that the flange 20 will attach to the appropriate holder 60.

The attachment mechanism 10 is preferably of a semi-cylinder circular body 24 on both sides. However, at generally the central area of the attachment mechanism 10, the flange area has an erect or boosted neck 51, so that a fastener can attach inside of such void area 53 of the flange area without interfering with any pivoting or rotating when the attachment mechanism is engaged to a support structure. The ability for the holder attachment mechanism 50 to rotate is because it is circular to match the congruent shape of for example, the elongate support member 20-A. generally outer wall. The erect or boosting of such described also allows any potential wires 99 to pass under any appropriate holder 60. At the opposing ends of the body 55 and the most opposite end from the flange 52 is a pair of handle-guides 57. The handle-guides 57 are used to guide the attachment mechanism 10 onto a supporting structure and also as finger handles to pry open the body 55 to help engage and disengage around a supporting structure. The handle-guides 57 are generally planar and integrated to the body 55 at each end. Though the holder attachment mechanism 50 preferably is able to rotate around a circular or circular-like, rod-like, or pole-like structure, it preferably has a resilient jacket such as a rubber coating (not shown). Thus, providing a better gripping surface to both the user and to the surface to which it (holder attachment mechanism 50) will be attached. And also to help prevent scratching or tearing a surface to which it is attached. FIG. 4 also shows how two or more holder attachment mechanisms 50 can be used for greater support and stability, depending on the weight of a holder and what will be supported in such holder 60. Also, the holder attachment mechanisms can be joined in a more permanent manner for example, by drilling a hole or holes through the side of the body 55 into the elongate support member 20.

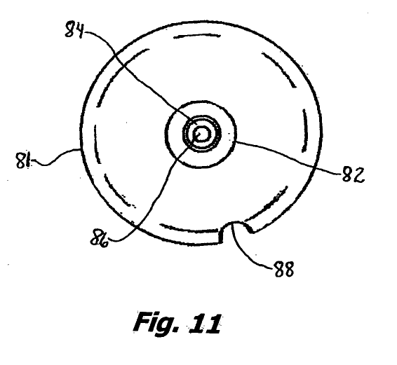

Referring particularly to FIG. 4, FIG. 6, and FIG. 11, the invention also includes a means for freestanding which can be an stand-base 80 made of a rigid, structural material. The stand-base 80 material is preferably be made of a relatively heavier material such as steel or oak wood as opposed to a relatively lighter material such as aluminum or plastic. The stand-base 80 can be of any structurally stable shape to keep the engaging unit from falling over from normal usage. Such structurally stable shape can be formed from square, triangular, and various other shapes and such derivatives.

The particular stand base illustrated is a general purpose stand base considering a combination of generally desired attributes. However, in such a field potentially related to furniture, aesthetics, and décor, it may be best that a manufacturer make a variety of base stands so that a consumer can choose a stand that best matches the particular décor, needs, and/or desires of such user.

The stand-base 80 in the illustrated embodiment has a generally circular contacting edge 81 at its outer end which makes contact with a horizontal surface that it is supported on. The stand-base 80 is preferably rounded upwardly and inwardly from the contacting edge 81 thereof to form a convexed upper side that is generally planar centrally, and a concaved under side that is generally planar centrally. The concaved side of the stand-base 80 faces down and is supported by a generally horizontal structure such as a floor or shelf of sufficient size if in use.

The stand-base 80 in the illustrated embodiment provides a braced-like support-neck 82 that projects from the convexed side central planar area. In the illustrated embodiment, the support-neck 82 is circularly rounded on its outer surface and is tapered or angled to have a relatively smaller diameter portion on its apex end thereof as to define a frustroconical projection. Alternatively, a support neck may be a separate part joined with fasteners such as screws or the like. The support-neck 82 is preferably of generally solid thickness except in the area of which a socket or engagement bore 84 is situated and aperture 86 thereof. The engagement bore 84 is situated from the central apex end of the support-neck 82 extending vertically downwardly to a general level of which the upper surface of the stand-base 80 would be without the support-neck 82, but not through the stand-base 80. The engagement bore 84 is designed to mate with a portion of whichever end of the elongate support member 20 that is being used as the lower end of the elongate support member 20. Thus, if the outer surface of the elongate support member 20 is of round cross section, then the engagement bore 84 will be of round cross section having a similar diameter. If the outer surface of the elongate support member 20 is of rectangular or of other cross section, the engagement bore 84 will have a shape corresponding to it. On the central bottom of the engagement bore 84 is preferably an annular shaped aperture 86 that extends through the bottom of the stand-base 80 to allow any possible wires 99 and associated plug types to pass through such aperture 86.

The stand-base 80 also preferably provides at least one via-port 88 at its outer contacting edge 81 that is preferably arch or half-circle shaped which will allow at least one wire 99 to pass through when the stand-base 80 is supported by a horizontal surface. Though most of the drawings depict the via-port 88 on the frontal portion of the stand-base 80, such drawings are for easier visualization reference, and the via-port/s 88 can be adjusted by the user to a general direction that such wires are leading to or from.

Whichever end of the elongate support member 20 that is being used as the lower end is preferably mutually engageable and disengageable and is rotatably supported inside of the engagement bore 84 if the stand-base 80 is in use. If the elongate support member 20 is indeed desired to be rotatably supported inside of the engagement bore 84, a lubricant such as grease can be applied inside of the engagement bore 84 on the surface thereof if the prop 60 is desired to rotate more easily. Alternatively, the stand-base 80 can be joined rigidly to the lower end of the elongate support member 20 by the user if desired, particularly once the user has the unit set in a desired position and elects to use the apparatus in such manner permanently. The lower end of the elongate support member 20 can be more permanently joined to the engagement bore 84 with the use of an adhesive such as polyurethane glue if desired. The stand-base 80 in the illustrated embodiment when used in conjunction with the elongate support member 20 defines a freestanding means that also hides and protects wires and diverges wires toward a user needed or desired location.

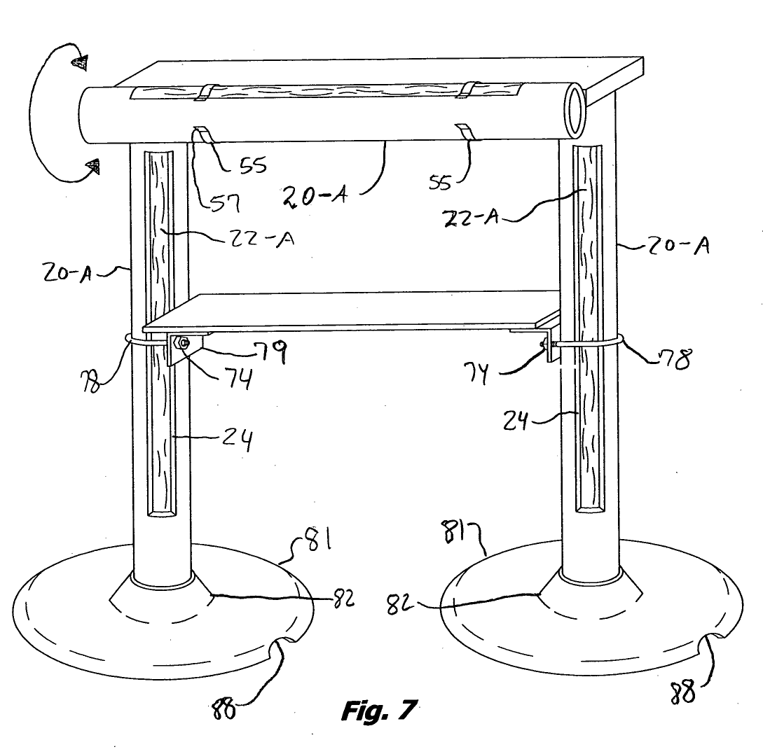

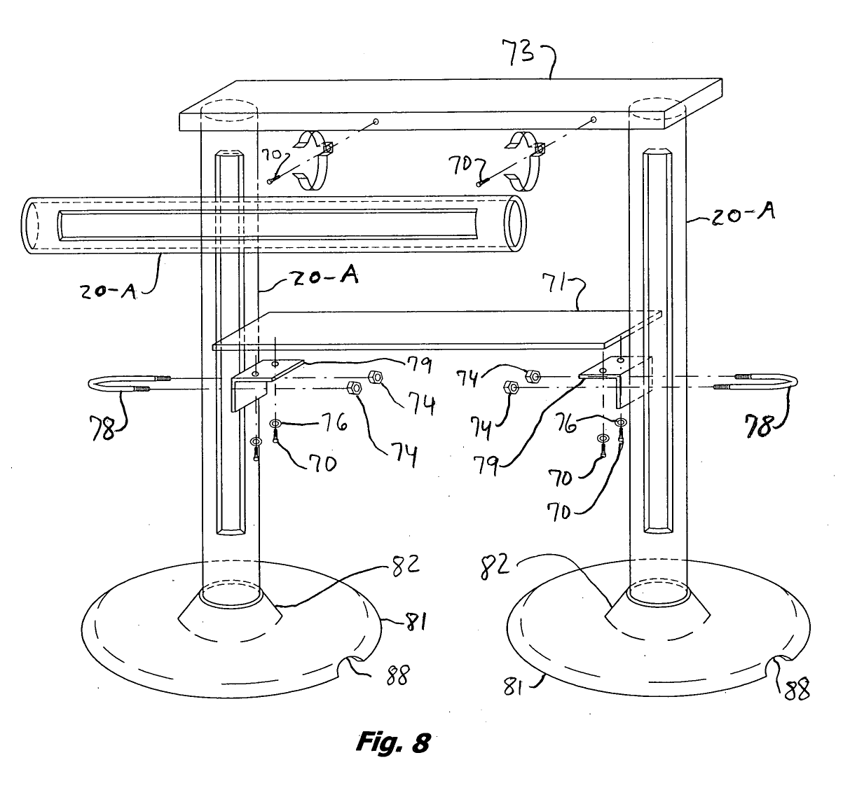

Referring to FIG. 7 and FIG. 8, the elongate support member 20 can be used structurally to build a desk, desk-like, entertainment center, or entertainment center-like structure. And the holder attachment mechanisms 50 can also be used as attachment mechanisms 40 to attach the tube-like structure 20-A to a thick enough shelf 73 that will support such on its vertical plane thereof. Screws 70 can join to such thick enough shelf 73 through the holes 54 of the butting flange 52 thereof. Then, the tube-like structure 20-A can engage or join into such holder attachment mechanisms 50 and be rotated to permit the channel portion orientation according to the user needs or desires. An ordinary shelf 71 can be joined between two elongate support members 20 with the use of what is commonly known as U-bolts 78, mounting brackets 79, screws 70, and washers 76. Those skilled in the art would know how to assemble such arrangement, particularly after viewing the drawings.

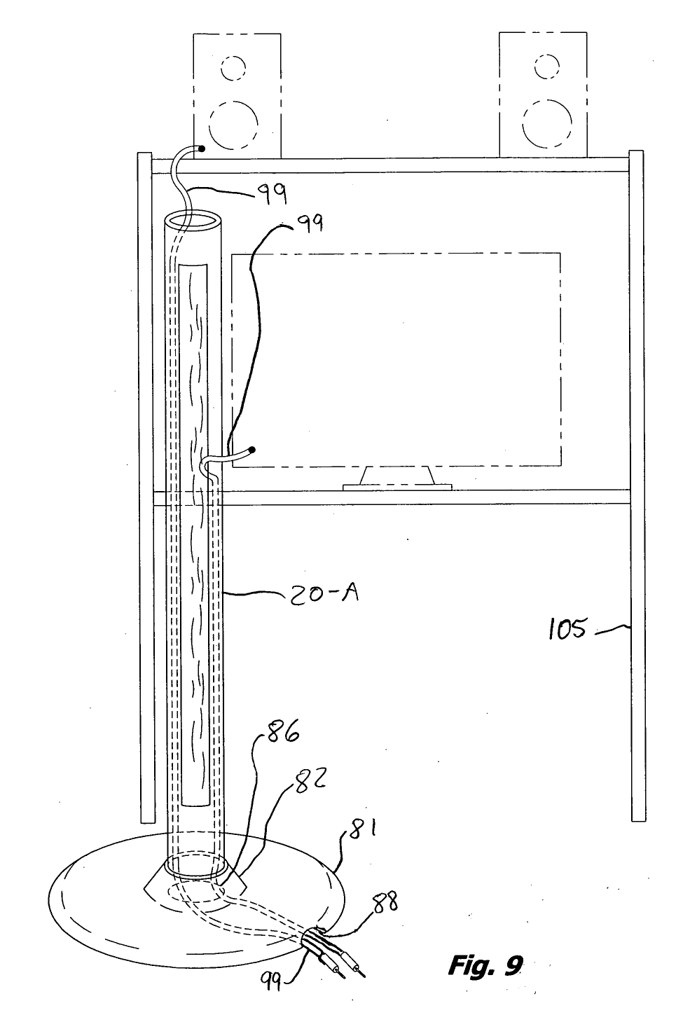

Referring to FIG. 9, the invention is used to assist the furniture of an entertainment center 105 or the like structure with wire management capabilities, but can also be used in the same manner for a desk or the like structure. The base can be positioned in front of, beside, or behind such structures at a location needed or desired by the user. And the channel means can be aligned facing the needed or desired direction.

### FIGS. 14-17—Alternative Embodiments

There are many and various possibilities in regard to the embodiments of the elongate support member 20 and resilient strip and the relationships thereof, that will accomplish substantially the same results in substantially the same manner. Disclosed in this alternative embodiment section of the description is two alternative embodiments to illustrate other preferred embodiments.

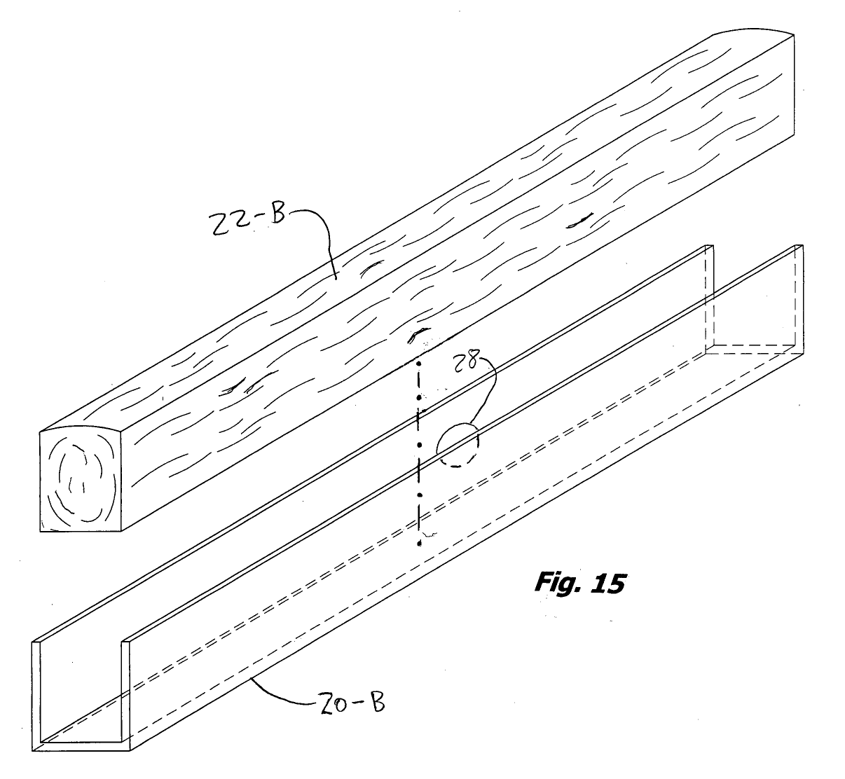

Referring to FIG. 14 and FIG. 15, the embodiment of the elongate support member 20 is shown to be a generally u-shaped elongate channel structure 20-B. Because the channel structure 20-B is a channel in and of itself, no separate channel 24 needs to be made. The channel structure 20-B is also preferably made of a rigid, structural, light material such as aluminum or plastic. In the illustrated embodiment of the channel structure 20-B, the at least one additional or optional wire flow or via passage or hole 28 is located on a wall that is perpendicular to the opening side (but not the open ends) of the channel structure 20-B. But such hole 28 can be located on the opposing side of the open side (not the open ends) of the channel structure 20-B.

The resilient strip 22 in the embodiment shown in FIG. 14 and FIG. 15 is also preferably the same kind of material as described for the cushion 22-A designed to be fitted inside of the tube-like structure 20-A as previously described. Thus, since said cushion 22-A is described to be preferably made of foam, the embodiment of the resilient strip 22 to be described in FIG. 14 and FIG. 15 will be referred to as the full description “foam cushion 22-B” rather than just “cushion 22-A” to avoid any possible confusion. The foam cushion 22-B is of congruent outer wall cross section as the inner wall cross section shape of the channel structure 20-B.

Like the cushion 22-A, the foam cushion 22-B is preferably made of foam and of a resiliency similar to that commonly made for furniture such as sofas and bedding, such as that made generally from regular polyurethane, or similar kind of bounce-back or sponge-like material. However, it can also be made from what is commonly known as memory foam or visco-elastic polyurethane foam. The resiliency of the foam cushion 22-B should be puissant or firm enough to hold or engage items relatively securely in place when wedged between the concaved side of the channel structure 20-B and the foam cushion 22-B. However, the resiliency of the foam cushion 22-B should not be too puissant or firm that it would substantially interfere with ease of inserting items between the concaved side of the channel structure 20-B and the foam cushion 22-B.

The foam cushion 22-B has a similar diameter cross section on its outer wall width as the inner wall width cross section of the of the channel structure 20-B. However, because the foam cushion 22-A is resilient, it can have a slightly larger diameter outer width wall than the inner width wall of the channel structure 20-B. Thus, allowing the cushion 22-A to bulge slightly outward of the channel structure 20-B.

Though not shown, the foam cushion 22-B is preferably surfaced with a decorative fabric such as vinyl, leather, or other materials, as are commonly used for surfacing furniture such as a sofa or couch. Also, though not shown, the channel structure 20-B can also be covered in decorative fabric such as leather, vinyl, or other materials, as are commonly used for surfacing furniture, which may be desired to match such decorative fabric that may surface the foam cushion 22-B. And the channel structure 24 provides a method to wrap such decorative fabric around such channel structure 20-B without visible seams. The decorative fabric would wrap around the convexed side of the channel structure 20-B, and into a portion on both sides of the concaved side of the channel structure 20-B, wherein the decorative fabric can be glued to portions of the inside walls of the channel structure 20-B.

The channel structure 20-B can be placed directly on a horizontal surface such as a shelf or horizontal plane area of a desk 100. It can also be attached with other orientations such as vertically. For example, by drilling holes (not shown) through the wall opposing the open side of the channel structure 20-B and inserting screws 70 through such holes and screwing such side to a planar surface.

If holder attachment mechanisms 50 are to be used on such channel structure 20-B, they may not to be able to be made or made easily wherein such holder attachment mechanisms 50 can be either able to be rotated, or attached at more of the 360 degrees of attachment as the previous tube-like structure 20-A described. But the practicality of attaching such holder attachment mechanism 50 to the channel structure 20-B may be that only four basic angles of attachment could be provided for the holder attachment mechanism 50.

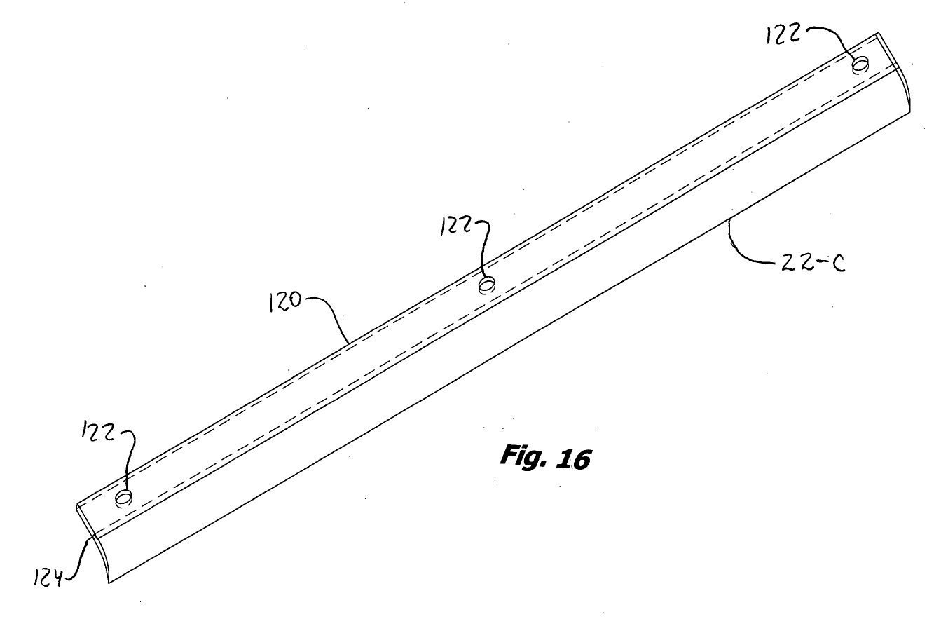

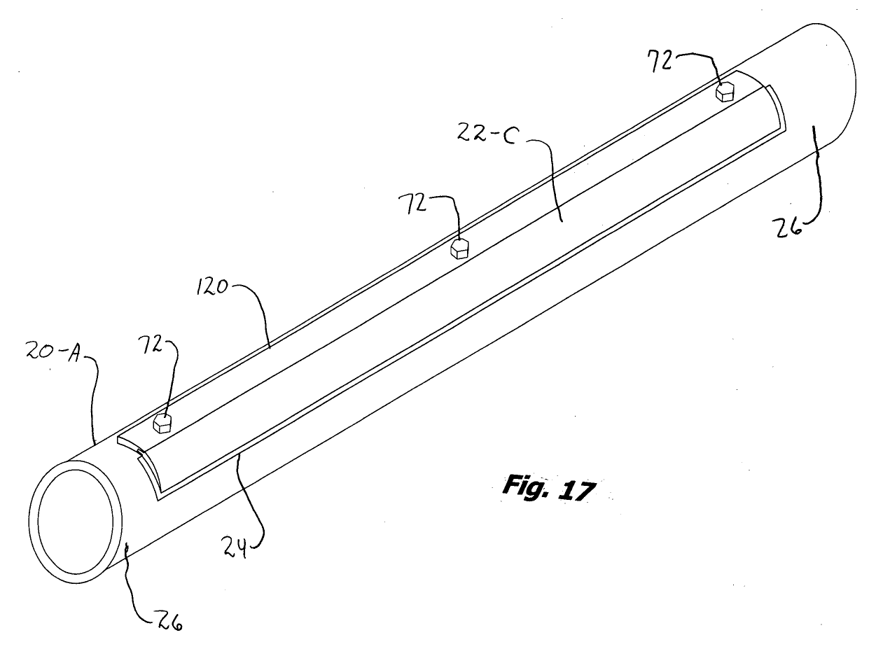

Referring to FIG. 16 and FIG. 17, you could start with the same tube-like structure 20-A as previously described. Then, add an embodiment similar to what is commonly known as a door sweep that attaches to a door at the bottom area to block wind and air draft. You would have flat generally rigid bar 120 made of a material such as aluminum or tin, with fastener holes 122 so that screws 70 or bolts 72 could pass through for joinery. Then you would have a resilient flange 22-C with a portion of one of its sides crimped into a crimping channel 124 of such bar 120. The flange 22-C would be made of a resilient material such as vinyl or rubber and be crimped coaxially to a side of such bar 120. Then, the bar could be fastened to the tube-like structure 20-A preferably with the bar 120 on the concaved side of tube-like structure 20-A, though it is shown fastened to the outer wall of the tube-like structure 20-A for clarity. Various fasteners such as screws 70, bolts 72, or eyelets (not shown) could be used to fasten such bar to the tube-like structure 20-A. Glue such as polyurethane glue could also be used to fasten such bar 120 to the tube-like structure 20-A. The bar 120 and the flange 22-C would align coaxially with the channel 24 of the tube-like structure 20-A. The flange 22-C would cover the opening of the channel 24 or at least a greater portion thereof.

Wires 99 and other items could be wedged into or through such channel by prying back the flange 22-C. However, this method would not keep wires 99 snug inside of the tube-like structure 20-A. Which, may or may not be needed or desired by the user. Also, this method could limit wedging angles of items inserted through the channel 24. Because for example, with the use of a cushion 22-A, you could wedge items to either side of the channel 24, thus angling such items according to which side of the channel 24 that such items are wedged against. Also, if for example an elongate support member 20 is something like the channel structure 20-B previously described, with the use of the foam cushion 22-B, wires 99 and other items could be wedged against either perpendicular wall to the opening side of the channel structure 20-B, thereby creating item and wire separation abilities.

### Operation

Operation of the invention is obvious after inspecting the drawings and reading the above descriptions including the background, summary, brief description of the drawings and detailed description.

### Conclusion and Scope

Although the description above contains many specificities, these should not be construed as limiting the scope of the invention but merely providing illustrations of some of the presently preferred embodiments of this invention. For examples, the elongate support member 20 can have curvature similar to an embodiment of a merging technology possible invention. The open ends 26 on all embodiments shown could be closed. The resilient strip 22 could be made hexagonal or octagonal shaped, thus only the edges would of such hexagonal or octagonal resilient strip would engage or join inside such tube-like structure 20-A.

While the invention has been described with reference to at least one preferred embodiment, it is not intended to limit the scope of the invention to the particular system, structure, or form(s) set forth, but on the contrary, it is intended to cover such alternatives, modifications, and equivalents as may be included within the spirit and scope of the invention as defined by the appended claims.

What is claimed is:

1. An organizing apparatus comprising an embodiment of an elongate support member having a channel means, and a resilient strip coaxially butting at least to a portion of said elongate support member in a manner selected from the group consisting of rigidly joined and engaged.

2. An organizing apparatus according to claim 1 wherein said resilient strip is a cushion.

3. An organizing apparatus according to claim 2 wherein said cushion is a foam cushion.

4. An organizing apparatus according to claim 1 wherein said elongate support member has a circular outer wall whereby holders can be attached with a mechanism for a variety of attachment angles.

5. An organizing apparatus according to claim 1 further comprising a freestanding means.

6. An organizing apparatus according to claim 1 further comprising at least one holder attachment mechanism that can attach to any holder which structurally permits said holder attachment to be joined to said any holder.

7. An organizing apparatus according to claim 1 further comprising an attachment mechanism whereby said elongate support member can attach to a planar surface.

8. An organizing apparatus according to claim 7 wherein said attachment mechanism permits said elongate support member to be rotatably contacted in a manner selected from the group consisting of rigidly joined and engaged.

9. An organizing apparatus according to claim 6 wherein said holder attachment permits rotation around said elongate support member.

10. A wire management apparatus comprising an embodiment of an elongate support member having a channel means, and a resilient strip coaxially butting at least to a portion of said elongate support member in a manner selected from the group consisting of rigidly joined and engaged.

11. A structure building enablement comprising an embodiment of an elongate support member having a channel means, and a resilient strip coaxially butting at least to a portion of said elongate support member in a manner selected from the group consisting of rigidly joined and engaged, whereby said structure building enablement could assist with organizing or wire management to a built-on complete structure.
